(19) United States
(12) Patent Application Publication
(10) Pub. No.: US 2020/0131696 A1
(43) Pub. Date: Apr. 30, 2020

(54) METHOD FOR CONTINUOUSLY PRODUCING A PATTERN AT THE SURFACE OF A FLEXIBLE SUBSTRATE AND RELATED APPARATUS

(71) Applicant: F.D.S., GENAY (FR)

(72) Inventor: Philippe SERRE, COLLONGES-AU-MONT-D'OR (FR)

(73) Assignee: F.D.S., GENAY (FR)

(21) Appl. No.: 16/626,433

(22) PCT Filed: May 2, 2018
(86) PCT No.: PCT/FR2018/051086

§ 371 Date: Dec. 24, 2019

(30) Foreign Application Priority Data
Jun. 27, 2017 (FR) 1755901

(51) Int. Cl. D06N 3/00; C09D 175/04; B05D 1/28; B05D 3/04; D06N 3/14

(52) U.S. Cl. CPC D06N 3/0095; C09D 175/04; D06N 3/14; B05D 3/046; B05D 1/28

(57) ABSTRACT

The invention relates to a method for continuously producing a pattern at the surface of a flexible substrate, comprising a step of forming a primary pattern by means of an operation of coating said substrate with a hot melt composition that is in the molten state, characterized in that said composition is a reactive polyurethane composition that is moisture crosslinkable to form a thermosetting polyurethane and in that said method comprises, after said coating operation, a step of moisture crosslinking the composition forming the primary pattern to obtain a secondary pattern made of thermosetting polyurethane. The invention also relates to a facility relating to such a method for coating on flexible substrates.

### TECHNICAL FIELD

The present invention relates to the general field of methods for producing patterns by coating on flexible substrates. The invention also relates to the technical field of facilities for implementing such methods.

The invention more particularly relates to a method for continuously producing a pattern at the surface of a flexible substrate, comprising a step of forming a primary pattern by means of an operation of coating said substrate with a hot melt composition that is in the molten state.

The invention further relates to a facility for continuously producing a pattern at the surface of a flexible substrate, comprising a station for forming a primary pattern by means of a device for coating said substrate with a hot melt composition that is in the molten state.

### PRIOR ART

A method and an associated facility for producing a relief pattern at the surface of a flexible substrate, that implement a polymer hot melt composition, are already known. Previously brought to the molten state, this composition is coated on the flexible substrate, so as to form at the surface of the latter a rough pattern that, after cooling and solidification of the composition, leads to the desired relief pattern.

If such a method and associated facility are generally implemented relatively simply, the pattern produced by means of these latter isn't always satisfying in terms, in particular, of physicochemical resistance. Still more specifically, the mechanical resistance of said pattern to high temperatures, to delamination and to abrasion (in particular after repeated cycles of rubbing of the coated substrate) may appear insufficient. Moreover, the chemical resistance of the pattern, in particular to solvents, may also sometimes appear limited for certain applications of the coated substrate.

Consequently, the objects assigned to the invention aim at remedying the drawbacks exposed hereinabove and at proposing a new method and a new facility, which allow producing particularly resistant patterns by coating, in a simple and efficient way, without however requiring the implementation of complex specific skills or technical means.

Another object of the invention aims at proposing a new method and a new facility that allow continuously processing a flexible substrate, for a controlled cost price.

Another object of the invention aims at proposing a new method and a new facility that allow producing patterns having both aesthetic and functional functions.

Another object of the invention aims at proposing a new method and a new facility that allow producing, reliably, repeatably, simply and efficiently, a pattern at the surface of flexible substrates of very various natures and compositions.

### DISCLOSURE OF THE INVENTION

The objects assigned to the invention are achieved by means of a method for continuously producing a pattern at the surface of a flexible substrate, comprising a step of forming a primary pattern by means of an operation of coating said substrate with a hot melt composition that is in the molten state, characterized in that said composition is a reactive polyurethane composition that is moisture crosslinkable to form a thermosetting polyurethane and in that said method comprises, after said coating operation, a step of moisture crosslinking the composition forming the primary pattern to obtain a secondary pattern made of thermosetting polyurethane.

The objects assigned to the invention are achieved by means of a facility for continuously producing a pattern at the surface of a flexible substrate, comprising a station for forming a primary pattern by means of a device for coating said substrate with a hot melt composition that is in the molten state, characterized in that said composition is a reactive polyurethane composition that is moisture crosslinkable to form a thermosetting polyurethane and in that said facility comprises, downstream from said primary pattern formation station, a station for moisture crosslinking said composition forming the primary pattern to obtain a secondary pattern made of thermosetting polyurethane.

### BRIEF DESCRIPTION OF THE DRAWINGS

Other objects and advantages of the invention will appear and be revealed in more detail by reading the following description, with reference to the appended drawings, given only by way of illustrative and non-limitative examples, in which:

FIGS. 1 to 5 schematically illustrate, in top view, different examples of the pattern that may be advantageously produced thanks to the method and facility according to the invention;

FIG. 6 schematically illustrates a preferred embodiment of the facility according to the invention.

### BEST WAY OF IMPLEMENTING THE INVENTION

According to a first aspect, the invention relates to a method for continuously producing a pattern, which is preferably predefined, at the surface of a substrate. It is preferentially an industrial method, advantageously automated, for processing substantially uninterruptedly a wide surface area of a given substrate.

According to the invention, said substrate is a flexible substrate, i.e. it constitutes a support having substantially no own stiffness and having, on the contrary, a certain flaccidity allowing its deformation, in particular under the effect of its own weight. Preferably, said substrate is in the form of a flexible surface sheet, and more specifically and advantageously, in the form of a long strip, for example 150 cm width, of a material (or an assembly of materials) having a sufficient suppleness and flexibility to be wound or folded over itself. Preferably, the method of the invention comprises a step of providing the substrate to be processed, which may possibly be in the form of a reel of longer or shorter length.

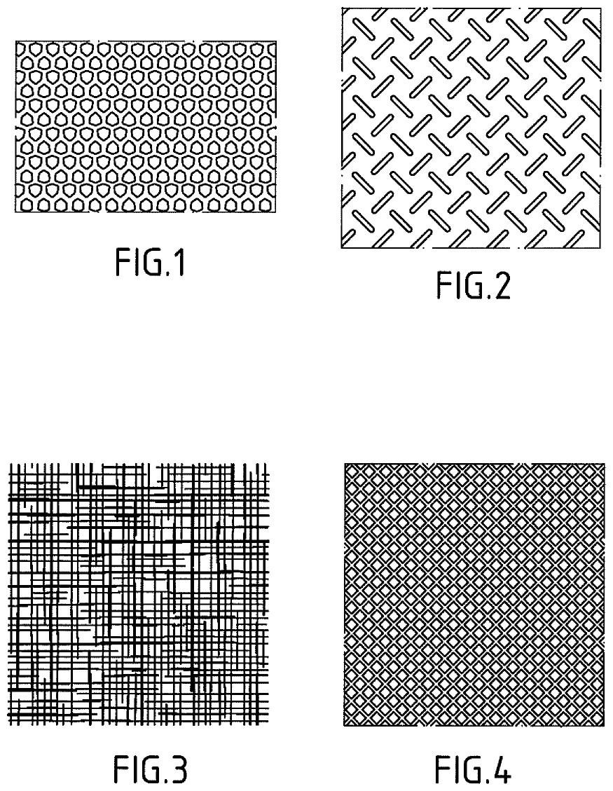

As mentioned hereinabove, said pattern is produced, according to the method of the invention, at the surface of said substrate, i.e. in the immediate vicinity of the surface of one and/or the other of the opposite faces of the latter. The pattern may hence be produced either in relief, and hence protrude in a observable way (in particular, to the naked eye or to the touch) from the surface of the substrate, or substantially “flat” on the surface of the latter, or also in the thickness of said substrate so as to make flush with the surface of the latter. Said pattern may have a purely aesthetic function, and then only aim at giving the considered substrate a particular and distinct visual aspect or feel, and/or a technical function, aiming for example at improving the resistance of the substrate to abrasion and to wearing. The general shape of this pattern is however not specifically limited, and may vary according to the aimed application and the wanted function, whether the latter is functional (anti-rubbing function (FIGS. 1 and 3) or anti-skid function (FIGS. 2 and 4), for example), or aesthetic, or even both functional and aesthetic.

According to a variant, illustrated in FIGS. 1 and 2, the pattern produced according to the method of the invention is a discrete, i.e. discontinuous pattern. It may for example be formed of a plurality of distinct points or punctual elements, spaced apart from each other, identical or not. Hence, said pattern may, for example, be formed of a set of circular elements, of generally polygonal “shield”-shaped elements (FIG. 1), of “diamond” or “rice grain”-shaped elements (FIG. 2), or of chevron-shaped elements (“A” or inverted “V” shape). In particular, in the case where said pattern have for purpose to improve the resistance of the substrate to abrasion, a pattern formed of points or distinct elements relatively close to each other, typically spaced apart by less than 5 mm, preferably less than 1 mm (for example, 0.8 mm in the example illustrated in FIG. 1) can advantageously be used.

According to another variant, illustrated in FIGS. 3 to 5, said pattern may on the contrary be continuous and openwork, and be for example in the form of criss-cross lines (FIG. 3), materializing for example a continuous network resisting to the abrasion factor or offering a “frost” effect, as a grid (FIG. 4), or as an ornamental drawing, for example lace (FIG. 5). Advantageously, the points or elements of the produced pattern do not cover the whole surface area of said substrate, so that the substrate processed by the method according to the invention keeps a certain flexibility, in particular sufficient to allow a possible latter winding of said processed substrate.

In order to produce such a pattern, the method according to the invention comprises a step of forming a primary pattern, i.e. a prepattern that prefigures the pattern (or final pattern) that is desired to be produced and obtained in fine at the surface of the considered flexible substrate. According to the invention, this step is performed by means of an operation of coating said substrate with a hot melt composition that is in the molten state (“hot melt” method). Unlike other known coating techniques, the coating operation of the method of the invention hence implements no aqueous-phase liquid composition or solvent. Using a composition that, at the initial state, is on the contrary advantageously in a 100% solid form, said coating operation is hence of particularly easy and safe implementation, and requires in particular no complex and expensive operation of recovery and reprocessing of waste waters or organic solvents dangerous for humans and for the environment.

More specifically, said composition is, according to the invention, a reactive polyurethane composition that is moisture crosslinkable (in presence or not of a catalyst) to form a thermosetting polyurethane, and still more precisely and advantageously, a composition of hot melt reactive polyurethane (HMPUR) adhesive. Particularly advantageously, said composition will be chosen for its ability to form, after cooling and crosslinking, a thermosetting polyurethane resisting to particularly high temperatures, for example 200° C. during 60 s.

The method of the invention also comprises, after said coating operation, a step of moisture crosslinking the composition forming the primary pattern to obtain, from said primary pattern, a secondary pattern made of thermosetting polyurethane that is fully crosslinked and hence not reactive. Preferably, said secondary pattern then forms directly the final pattern that is desired to be produced. As an alternative, and without departing from the framework of the invention, the method according to the invention may optionally comprise one or several additional steps (surface treatment, etc.) aiming for example at modifying the appearance or the properties of said secondary pattern in view to obtain in fine said final pattern.

Hence, the secondary pattern is obtained from the primary pattern, on the one hand, physically by cooling and freezing of the composition forming the primary pattern (passage from the molten state to the solid, frozen state) and, on the other hand, chemically and irreversibly by crosslinking of the latter.

During said crosslinking step, and preferably up to the end of the latter, said primary pattern remains preferably in the open air, i.e. the surface of the primary pattern that is not in contact with the surface remains free. In other words, the primary pattern is not intended, as such, to ensure the bonding of the flexible substrate with a potential additional layer that would be superimposed to said primary pattern and to said substrate.

The choice of such a hot melt composition is particularly interesting in that, in particular, unlike a thermoplastic polymer composition, the composition of the method according to the invention leads to obtaining a pattern made of thermosetting polymer material (herein, a polyurethane) that is hence non-melting and insoluble. The pattern made according to the method of the invention has hence an excellent mechanical and chemical resistance, in particular to abrasion and delamination, even after a great number of rubbing cycles of the coated substrate. Said pattern has moreover an excellent heat resistance. In particular, according to the nature of the chosen hot melt reactive polyurethane adhesive composition, the pattern obtained from the latter is liable to resist to temperatures from −40° C. to sometimes more than 150° C., without significant degradation of its mechanical properties. It hence notably becomes advantageously possible to subject a substrate processed according to the method of the invention to a latter thermoforming operation, aiming for example at providing the latter with a three-dimensional spatial configuration, without thereby degrading the pattern produced.

Moreover, unlike the heat- or UV-crosslinkable hot melt compositions, such a moisture-crosslinkable composition does not necessarily require specific and complex crosslinking equipment or technical means, as the crosslinking can indeed occur under the only action of the relative moisture of the surrounding ambient air or of that contained in said substrate. This means that the crosslinking step of the method according to the invention may then advantageously correspond to a passive step, i.e. a step during which the composition of the primary pattern is let crosslink naturally under the ambient moisture, without particular external intervention.

Preferably, said hot melt composition will be chosen with a very short open time, for example comprised between 15 and 30 s, and a total crosslinking in about 24 h under a relative moisture rate of 55% for a primary pattern thickness of the order of 500 μm.

Preferably, said coating operation is performed by transfer of said composition in the molten state to the flexible substrate by means of an engraved cylinder, i.e. by means of a cylinder whose external surface is provided with one or several cavities (or cells), intended to receive said molten composition and whose shape is representative of that of said primary pattern. Still more preferentially, said coating operation is performed by direct transfer from said engraved cylinder to said flexible substrate. In other words, said coating operation advantageously implements no intermediate transfer carpet or support, on which the primary pattern would be produced by deposition of said molten composition, before transfer of said primary pattern to said substrate.

Preferably, said hot melt composition is previously brought to the molten state, preferably at a temperature comprised between 80 and 170° C. and, for example, in a suitable melter, before being deposited on the surface of said engraved cylinder to fill the cavity(ies) present at the surface of the latter. A doctor blade, or a similar device, may advantageously be implemented to evacuate the excess of molten composition at the surface of the cylinder. Advantageously, the surface of the engraved cylinder is brought and held at a high temperature, preferably substantially close to the melting point of said composition, so as to accurately control the viscosity of the latter. Indeed, the control of the molten composition viscosity makes is possible to favour a good filling/emptying of the cavities of the engraved cylinder and to control (i.e. to favour or, on the contrary, to avoid) the potential diffusion, on and into the thickness of the substrate, of the deposited composition. Preferably, the surface of the substrate to be coated is then brought in direct contact with the external surface of the engraved cylinder, and preferentially held pressed (at least locally) against the latter by means for a counter-cylinder. Hence, the rotation of the engraved cylinder provides the direct transfer on said substrate of said molten composition.

As an alternative, a coating operation performed by transfer by means of a rotary frame may be contemplated. As another alternative, said coating operation may be performed by means of one or several nozzles, mobile or not, adapted to deposit said composition, in the molten state, at the surface of the substrate.

Advantageously, the method according to the invention may comprise an operation of primary heating (for example by means of a primary IR radiant heater) of the primary pattern formed. Preferably, performed immediately after said coating step, this primary heating operation will advantageously help to obtain the desired definition for said primary pattern, by regulating the viscosity of the composition forming the latter and by avoiding in particular that the composition that forms said primary pattern freezes too rapidly. In particular, the shape defects that could be observed in case of too rapid freezing of the composition immediately after deposition of the latter on the substrate will hence be limited.

Optionally, the method according to the invention may also comprise, after said step of forming the primary pattern, a step of laminating the substrate surface, on which has been formed said primary pattern, in order to control the thickness and surface aspect (flattening, mattifying, etc.) of the latter, and/or the depth of penetration thereof into the substrate thickness.

Preferably, the method according to the invention comprises, after said step of forming the primary pattern, a step of winding (for example into a reel), stacking or folding over itself the coated flexible substrate, for example for its transportation and for potential operations of transformation or manufacturing at the end of the method of the invention.

For the industrial production rate to be the highest possible, it has been judged desirable that such a winding step occur in this case the most rapidly possible after said step of forming the primary pattern. However, if the composition forming said primary pattern is not yet crosslinked enough, there exists an important risk of deformation of the primary pattern during the winding step and hence of obtaining of a final pattern that is not consistent with the expectations. This phenomenon is particularly problematic in the case where the pattern to be produced at the surface of the substrate is a relief pattern.

To eliminate this risk, the crosslinking step of the method of the invention preferably comprises an operation of pre-crosslinking the composition forming the primary pattern, so that, at the end of this pre-crosslinking operation, the composition forming the primary pattern is crosslinked enough, i.e. the crosslinking reaction is sufficiently initiated and advanced, to ensure a sufficient cohesion of the primary pattern and hence avoid any inadvertent and irreversible deformation of the latter.

Therefore, the crosslinking step of the method of the invention preferably includes an operation of subjecting said primary pattern to a flow, forced or not, of a gas or a gaseous mixture filled with moisture (for example, a flow of water vapour or moist air). In other words, the moisture crosslinking step of the method of the invention is at least partly active, i.e. forced and controlled. Preferably performed after the potential lamination step contemplated hereinabove, this operation of localized addition of moisture aims at substantially accelerating the reaction of crosslinking of the composition forming said primary pattern, by artificially increasing the relative moisture of the ambient air and of the substrate at the primary patter formed.

The flow rate of this flow of gas or gaseous mixture filled with moisture will be advantageously controlled and regulated so as to take into account the potential variations of environmental and climatic conditions, the substrate nature (material, moisture porosity, etc.) and the thickness of the primary pattern formed.

That way, it is advantageously possible to obtain satisfying winding speeds, wherein said winding step can advantageously be performed after (and preferably immediately after) said pre-crosslinking operation and before the end of said crosslinking step, and that without significant impact on the final pattern obtained. The crosslinking step may then continue whereas the coated substrate is wound, stacked or folded over itself, under the effect, on the one hand, of the natural relative moisture of the ambient air, but also advantageously, on the other hand, under the effect of the moisture retained by the substrate itself and resulting from the above-mentioned moisture addition.

As an alternative, such an operation of subjecting the primary pattern to a gaseous flow filled with moisture could perfectly be implemented, on a potentially more important time scale, to ensure the complete crosslinking (and not only a partial crosslinking) of the composition forming said primary pattern and hence to obtain said fully crosslinked polyurethane secondary pattern.

Moreover, the method of the invention preferentially comprises, before said step of winding, stacking or folding over itself of the coated flexible substrate, a step of forced cooling the primary pattern composition. If the primary pattern composition can be naturally and progressively cooled under the effect of the ambient atmosphere, such a forced cooling step advantageously allows accelerating the cooling thereof, in such a manner that said composition forming the primary pattern is cooled and frozen enough to avoid the risk of bonding of the coated flexible substrate to itself, due to the residual tackiness of said composition, during the winding. Said forced cooling step may be performed using any known means, and for example by passage of the coated substrate on one or several cooling cylinders. It will moreover be conceivable to implement a flow of cold air, of compressed air or inert gas, or also the putting into contact of the coated substrate with dry ice.

It is to be noted that such an optional cooling step may perfectly be independent of said crosslinking step, and in particular of said pre-crosslinking operation. It can from then on advantageously be made before or after, or even concomitantly with, these steps. Also, the respective implementation of said operation of submitting said primary pattern to a flow of gas filled with moisture and of said step of cooling the composition of the primary pattern is absolutely not exclusively linked to the implementation of a step of winding, stacking or folding over itself of the coated flexible substrate. Hence, it remains perfectly conceivable to implement such a moisture addition operation and/or such a cooling step, in the absence of any winding, stacking or folding over step, for example in view to be able to proceed to potential latter additional processing steps or operations, the more rapidly after said coating step.

Preferentially, the flexible substrate to which the method of the invention relates comprises a fabric, i.e. a textile surface piece. Such a fabric may be obtained by any known method, and for example knitting, weaving, paper-making means (“wet-laid” non-woven fabric) or also dry aerodynamic method (“air laid” non-woven fabric), of natural (cotton, linen, wool, silk, cellulose, etc.) or synthetic (polyester, polyamide, aramid, glass, carbon, stainless steel, etc.) fibres or wires, or also a mixture of such natural or synthetic fibres (or wires). Preferably, such a fabric will be chosen porous to moisture, and in particular to water vapour or moist air. Still advantageously, said fabric will also be chosen porous to said moisture crosslinkable reactive polyurethane composition when the latter is in the molten state, so as to allow said composition to penetrate at least a part of the thickness of said fabric.

In this preferential case where the flexible substrate comprises a fabric, said coating operation is then advantageously performed directly on said fabric, said moisture crosslinkable reactive polyurethane composition then preferably penetrating at least in part the thickness of the latter. In other words, the coating operation is then performed directly at the surface of said fabric, hence in the absence of any intermediate layer between the surface of the latter and the deposited composition forming the primary pattern. This however does not exclude that the fibres or wires of said fabric can themselves have received a surface treatment aiming, for example, at providing said fabric with a water-repellent character. That way, an efficient and sustainable anchoring to said substrate of the secondary pattern, and hence of the final pattern, after crosslinking of the composition forming the primary pattern, is favoured, and the risk of delamination, tearing, of said pattern is hence advantageously limited.

The depth by which the composition penetrates said fabric may advantageously be controlled by a suitable regulation of the viscosity of said composition in the molten state (via, for example, the choice of the temperature of implementation or the choice of the chemical nature of said composition), or also, optionally, by the compression effort exerted on the primary pattern during the additional lamination step mentioned hereinabove.

As an alternative, and without thereby departing from the framework of the invention, said substrate may on the contrary be formed of a film, a sheet or a flexible membrane, for example made of a polymer (PVC, polyethylene, etc.) or a metal (aluminium, etc.).

Advantageously, the method according to the invention may comprise, previously to said step of forming said primary pattern, a surface treatment step aiming at increasing the surface tension of said flexible substrate. For example of the Corona or plasma treatment type, such a surface treatment step advantageously allows improving the adhesion of the composition deposited on the substrate, when the latter has initially a low surface tension.

In order to still improve the definition (i.e. for example the accuracy, the fineness, the respect of the desired conformation) of the pattern produced, the method according to the invention may also comprise, previously to said step of forming said primary pattern, a step of calendering said substrate, in particular to smooth, flatten, the surface of the latter before said coating operation.

Advantageously, the method according to the invention may also comprise one or several operations of adding filler(s) and/or additive(s) into the moisture crosslinkable reactive polyurethane composition, in view of, on the one hand, facilitating the implementation of the method of the invention (rheological behaviour of the composition in the molten state, cross-linking speed, etc.) and, on the other hand, improving or modulating the mechanical (adhesion to the substrate, abrasion, fire or UV resistance, etc.) and/or aesthetic (colour, brightness, reflection, touch feeling, etc.) characteristics of the pattern obtained at the end of the method of the invention.

Therefore, the related filler(s) may be organic (wood powder, etc.), mineral (silica, glass beads, aluminium hydroxide, calcium and/or magnesium carbonates, etc.), metallic (gold, copper, nickel powders or flakes, etc.) or also synthetic (microcapsules containing an active agent or expanding agent, etc.). Among the conceivable additives, it may be mentioned, for example: one or several colouring agents (for example, powder metallic oxide(s)), a fluorescent or phosphorescent substance, a UV-inhibitor agent, an agent for catalysing the moisture crosslinking reaction, a mattifying additive, etc.

According to whether it is desired to modify the pattern properties in surface or in depth, the method of the invention may then advantageously comprise:
an operation of preparing and introducing these fillers and/or additives in the moisture crosslinkable reactive polyurethane composition in the molten state, preferably previously to said coating operation, and/or
an operation of sprinkling these fillers and/or additives at the surface of the formed primary pattern, after said coating step, and preferably after the potential lamination step.

Such a sprinkling operation may advantageously be preceded with a secondary heating operation (for example, by means of a secondary IR radiant heater) of the primary pattern in order to lower, if necessary, the viscosity of the composition forming the latter near the surface thereof, and to hence facilitate the incorporation of said fillers and/or additives.

The invention also relates, as such, to a facility 1 for continuously producing a pattern at the surface of a flexible substrate 2. The facility 1 in question is advantageously a facility for implementing a method for continuously producing a pattern at the surface of a flexible substrate according to the invention, so that the disclosure exposed hereinabove in relation with the method according to the invention remains valid and applicable, mutatis mutandis, to the present facility 1. It is preferentially an industrial facility, advantageously automated, adapted to process substantially uninterruptedly a wide surface area of a given substrate.

A particularly preferential embodiment of the facility according to the invention is schematically illustrated in FIG. 2. The arrows present in FIG. 2 indicate the preferential direction of progression of said substrate 2 with respect to the different stations and devices comprised by said facility 1, and which will be described in detail hereinafter. The terms “upstream” and “downstream” used hereinafter will have to be preferentially interpreted in consideration of the direction of progression indicated by these arrows (and independently of any altitude of one or the other of said stations and devices).

The facility 1 according to the invention comprises a station 3 for forming a primary pattern by means of a device 4 for coating said substrate 2 with a hot melt composition that is in the molten state. As exposed hereinabove, said substrate 2 is a flexible substrate, which preferably comprises a fabric. The pattern in question is itself preferably a discrete, discontinuous pattern. The hot melt composition to which the facility according to the invention relates is a reactive polyurethane composition that is moisture crosslinkable to form a thermosetting polyurethane, advantageously in accordance with the description thereof that has been made hereinabove in connection with the method of the invention.

Preferably, said coating device 4 is a transfer coating device comprising an engraved cylinder 5, i.e. using a cylinder whose external surface is provided with one or several cavity(ies) (or cell(s), intended to receive said molten composition and whose shape is representative of that of said primary pattern. Said engraved cylinder 5 may for example be made of chromium steel or chromium-copper steel. Preferably, said coating device 4 also comprises a counter-cylinder 7 adapted and arranged to maintain said substrate 2 in close contact with the surface 6 of the engraved cylinder 5.

Still more preferentially, said coating device 4 is a coating device implementing direct transfer from said engraved cylinder 5 to said flexible substrate 2. In other words, said coating device 4 is advantageously devoid of intermediate transfer carpet or support, on which the primary pattern would be produced by deposition of said molten composition, before the transfer of said primary patter to said substrate 2. Said coating device 4 is hence relatively simple and easy to implement.

Preferably, said engraved cylinder 5 is equipped with means for heating and regulating the temperature of its engraved surface 6. This heating and regulation means may be internal to said engraved cylinder 5 (heat transfer fluid, electrical resistance or other) or external (for example, an IR radiant heater positioned above said engraved cylinder 5, opposite the surface 6 of the latter). That way, the surface 6 of the engraved cylinder 5 may advantageously be brought and held at a high temperature, preferably substantially close to the melting point of said composition, so as to control accurately the viscosity of the latter.

As an alternative, it may be contemplated that said coating device 4 comprises a rotary frame.

Preferably, said station 3 for forming a primary pattern comprises a means 8 for preparing said composition adapted to bring the latter to the molten state, preferably to a temperature comprised between 80 and 170° C., as well as a means for depositing said composition in the molten state at the surface 2 of the engraved cylinder 5. For example, of the melter type, said preparation means 8 may advantageously be held under an atmosphere whose relative moisture is particularly controlled (or even ideally under an atmosphere substantially devoid of any trace of moisture), so as to prevent as much as possible the presence of enough relative moisture to initiate and sustain the crosslinking reaction of said composition before the formation of said primary pattern. Said primary pattern formation station 3 may further advantageously comprise a doctor blade, or a similar device, adapted to evacuate the excess of molten composition deposited at the surface 6 of the engraved cylinder 5 and hence to ensure a good filling of the cavities of the latter and a good definition of the primary pattern.

Preferably, the facility 1 also comprises a device for supplying the substrate 2 to be processed, positioned upstream from said primary pattern formation station 3. Such a supply device may be of any known type and, for example, comprise a dispenser adapted to receive said substrate 2 to be processed, when the latter is advantageously wound into a reel, and a means for bringing the unwound substrate 2 towards the coating device 4 of said primary pattern formation station 3.

Advantageously, the facility 1 according to the invention may comprise a primary heating means 9 (for example, of the IR radiant heater type) of the primary pattern formed, preferably positioned immediately downstream from said coating device 4, as illustrated in FIG. 2. The presence of such a primary heating means 9 will help to obtain the desired definition for said primary pattern, by regulating the viscosity of the composition forming the latter and by avoiding in particular that the composition that forms said primary pattern freezes too rapidly.

Optionally, the facility 1 according to the invention may also comprise, downstream from said primary pattern formation station 3, a means 10 for laminating the surface of the substrate 2, on which has been formed said primary pattern, so as to control the thickness and surface aspect (flattening, mattifying, etc.) of the latter, and/or the depth of penetration thereof into the substrate thickness. As illustrated in example in FIG. 2, such a lamination means 10 may comprise a laminating cylinder 11 and a counter-cylinder 12, whose relative spacing is adjustable according to the pressure that is desired to be exerted on said primary pattern.

According to the invention, said facility 1 comprises, downstream from said primary pattern formation station 3, a station 13 for moisture crosslinking said composition forming the primary pattern to obtain, from said primary pattern, a secondary pattern made of thermosetting polyurethane. Preferably, said secondary pattern then forms directly, at the exit of said crosslinking station 13, the (final) pattern that is desired to be produced. As an alternative, and without thereby departing from the framework of the invention, the facility 1 according to the invention may optionally comprise one or several additional stations or means (surface treatment means, etc.) aiming for example at modifying the appearance or the properties of said secondary pattern in view to obtain in fine said final pattern.

As mentioned hereinabove in relation with the method of the invention, such a moisture crosslinkable composition does not necessarily require specific and complex crosslinking equipment or technical means, as the crosslinking can indeed occur under the only action of the relative moisture of the surrounding ambient air or of that contained in said substrate 2. From then on, the crosslinking station 13 of the facility 1 according to the invention may have no active means specifically adapted to ensure the crosslinking of said composition. In this case, said crosslinking station 13 will be advantageously merged with all or part of the means and devices of said facility 1 positioned downstream from the primary pattern formation station 3, and more specifically downstream from the coating device 4 of the latter, insofar as these latter are placed in an environment whose atmosphere has naturally a certain relative moisture sufficient to initiate and sustain the crosslinking reaction of the composition forming the primary pattern.

Preferably, the facility 1 according to the invention comprises a device 14 for winding (for example, of the winder type), stacking or folding over itself said coated flexible substrate 2, for example for its transportation and for potential operations of transformation or manufacturing at the end of the method of the invention. Said winding, stacking or folding over device 14 is in this case advantageously positioned downstream from said primary pattern formation station 3 and, preferably, downstream from said lamination means 9 contemplated hereinabove, as shown in

FIG. 2.

Preferably, said crosslinking station 13 comprises a means 15 for generating a flow, forced or not, of a gas or a gaseous mixture (or gaseous flow) filled with moisture (for example, a flow of water vapour or moist air). This means 15 for generating a gaseous flow filled with moisture is advantageously adapted for implementing the pre-crosslinking operation of the method of the invention described hereinabove, and hence constitutes, in other words, a device for pre-crosslinking the composition forming said primary pattern. Preferably comprising a water vapour generation ramp, said means 15 for generating a flow of gas or gaseous mixture filled with moisture is advantageously positioned upstream from said winding device 14. Taking into account the above description of the method of the invention, it is understood that such a pre-crosslinking device advantageously allows the pre-crosslinking of the composition forming said primary pattern previously to the winding of the coated substrate 2 by means of said winding device 14. Still preferably, said crosslinking station 13 also comprises a means for controlling and regulating the flow rate of said flow of gas or gaseous mixture, so as to take into account the variations of environmental and climatic conditions, the substrate nature (material, moisture porosity, etc.) and the thickness of the primary pattern formed.

It ensues therefrom that it is, from then on, possible, as already mentioned hereinabove in connection with the method of the invention, to reach very high production rates. So, in the absence of such a pre-crosslinking device, it would be necessary to use intermediate means (for example, of the accumulator type), potentially cumbersome and expensive, adapted to lengthen the time of travel of the substrate 2 between the primary pattern formation station 3 and said winding device 14, and to leave the composition forming the primary pattern the time to crosslink enough in the open air so that the coated substrate 2 can be wound without risk of deterioration of the pattern. The facility 1 is hence not very cumbersome and of relatively simple and cost-effective design.

Advantageously, the facility 1 of the invention comprises a device 16 for forced cooling the primary pattern composition, advantageously positioned upstream from said device 14 for winding, stacking or folding over itself the coated substrate 2. For example, as illustrated in FIG. 2, said cooling device 15 may comprise at least one or several cooling cylinders 17, preferentially positioned between said means 15 for generating a flow of gas or gaseous mixture filled with moisture and said device 14 for winding, stacking or folding over itself the coated substrate 2. As an alternative, said cooling device 15 may comprise a system for generating a flow of cold air, of compressed air or inert gas directed towards the flexible substrate 2 and the primary pattern formed at the surface thereof, or a means for putting the coated substrate into contact with dry ice. Such a cooling device 15 advantageously contributes, as the above-mentioned means 15 for generating a gaseous flow filled with moisture, to the compactness of the facility 1 and the improvement of the performances thereof in term of operating rate.

This being said, it remains perfectly conceivable, without thereby departing from the framework of the invention, that the facility 1 according to the invention comprises such a means 15 for generating a gaseous flow filled with moisture and/or such a cooling means 15, without thereby comprising a device 14 for winding (for example, of the winder type), staking or folding over itself said coated flexible substrate 2.

Advantageously, the facility 1 according to the invention may comprise, upstream from the station 3 for forming said primary pattern, a surface treatment station (not shown) adapted to increase the surface tension of said flexible substrate 2.

Comprising for example a surface treatment means of the Corona or plasma device type, such a surface treatment station advantageously allows improving the adhesion of the composition deposited on the substrate 2 by the coating device 4.

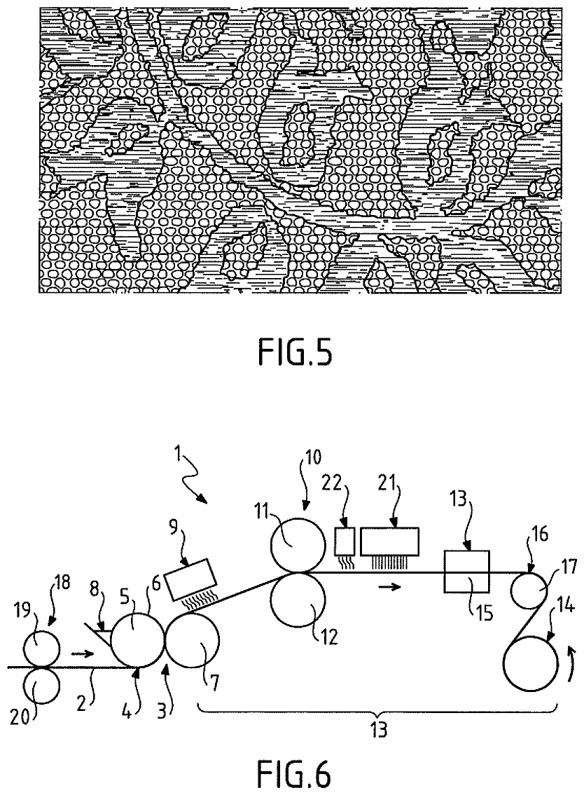

Preferably, the facility 1 may comprise, upstream from the station 3 for forming said primary pattern, a station 18 for calendering said substrate 2 to smooth, flatten, the surface of the latter. As illustrated in FIG. 6, this calendaring station will then preferably comprise at least one pair of calendering rolls 19, 20.

Advantageously, said facility 1 may also comprise one or several devices for adding filler(s) and/or additive(s) into the moisture crosslinkable reactive polyurethane composition, in view of, on the one hand, facilitating the implementation of the facility 1 of the invention (rheological behaviour of the composition in the molten state, cross-linking speed, etc.) and, on the other hand, improving or modulating the mechanical (adhesion to the substrate, abrasion, fire or UV resistance, etc.) and/or aesthetic (colour, brightness, reflection, touch feeling, etc.) characteristics of the pattern obtained using the facility 1 of the invention. These filler(s) and/or additive(s) are in this case advantageously in accordance with the description thereof that has been made hereinabove in connection with the method of the invention.

According to whether it is desired to modify in surface or in depth the properties of the pattern produced at the surface of the substrate 2, the facility 1 of the invention may then advantageously comprise:
a device (not illustrated) (for example, of the static mixer type) for preparing and introducing these fillers and/or additives into the moisture crosslinkable reactive polyurethane composition in the molten state, preferably positioned at the means 7 for preparing said composition, and/or
a device 21 for sprinkling these fillers and/or additives at the surface of the formed primary pattern, positioned downstream from the primary pattern formation station 3 and the coating device 4 thereof. Still preferably, as illustrated in FIG. 2, such a sprinkling device 18 will be positioned downstream from said lamination means 9, and also advantageously downstream from said means 15 for generating a gaseous flow filled with moisture.

As illustrated in FIG. 6, the facility 1 of the invention will then preferably comprise a secondary heating means 22 (for example, a secondary IR radiant heater, which will preferably be distinct from the primary heating means 8 contemplated hereinabove) for the primary pattern in order to lower, if necessary, the viscosity of the composition forming the latter near the surface thereof, and to hence facilitate the incorporation of said fillers and/or additives.

Finally, the method and facility of the invention allow the rapid, repeatable and efficient production, at the surface of a substrate, of a particularly robust and reliable predefined pattern. They do not require for that purpose the implementation of complex specific skills or technical means. As indicated in the above description, the pattern produced according to the methods and facility of the invention may have a functional and/or aesthetic purpose. A flexible substrate, at the surface of which a pattern will have been produced according to the invention, will find in particular an application in the field of coatings for seats (for example, car seats) and armchairs, personal protective equipment (PPE), luggage, clothes or also wall coverings.

### Possibility of Industrial Application

The invention finds its industrial application in the field of design and manufacturing of flexible substrates provided with patterns formed by coating, in the field of design and implementation of methods for producing such patterns by coating on flexible substrates, as well as in the field of design, manufacturing and use of facilities for implementing such patterns.

1. A method for continuously producing a pattern at the surface of a flexible substrate, comprising: a step of forming a primary pattern by means of an operation of coating said substrate with a hot melt composition that is in a molten state, characterized in that said hot melt composition is a reactive polyurethane composition that is moisture crosslinkable to form a thermosetting polyurethane; and in that said method comprises, after said coating operation, a step of moisture crosslinking said hot melt composition forming the primary pattern to obtain a secondary pattern made of said thermosetting polyurethane.

2. The method according to claim 1, characterized in that said pattern is discrete.

3. The method according to claim 1, characterized in that said coating operation is performed by transfer of said hot melt composition in said molten state to said substrate by means of an engraved cylinder.

4. The method according to claim 3, characterized in that said coating operation is performed by direct transfer from said engraved cylinder to said substrate.

5. The method according to claim 1, characterized in that said substrate comprises a fabric.

6. The method according to claim 5, characterized in that said coating operation is performed directly on said fabric, said hot melt composition penetrating at least in part a thickness of the latter.

7. The method according to claim 1, characterized in that said moisture crosslinking step includes an operation of subjecting said primary pattern to a flow of gas or gaseous mixture filled with moisture.

8. The method according to claim 1, characterized in that said moisture crosslinking step comprises an operation of pre-crosslinking said hot melt composition forming the primary pattern.

9. The method according to claim 8, characterized in that it comprises a step of winding said coated substrate over itself, wherein said winding step is performed after said pre-crosslinking operation and before the end of said moisture crosslinking step.

10. The method according to claim 1, characterized in that it comprises a step of forced cooling said hot melt composition of the primary pattern.

11. The method according to claim 1, characterized in that it comprises, previously to said step of forming said primary pattern, a surface treatment step, for example of the Corona treatment type, aiming at increasing a surface tension of said substrate.

12. The method according to claim 1, characterized in that it comprises, previously to said step of forming said primary pattern, a step of calendering said substrate.

13. A facility for continuously producing a pattern at the surface of a flexible substrate, comprising: a station for forming a primary pattern by means of a device for coating said substrate with a hot melt composition that is in said molten state, characterized in that said hot melt composition is a reactive polyurethane composition that is moisture crosslinkable to form a thermosetting polyurethane; and in that said facility comprises, downstream from said primary pattern formation station, a station for moisture crosslinking said hot melt composition forming said primary pattern to obtain a secondary pattern made of said thermosetting polyurethane.

14. The facility according to claim 13, characterized in that said coating device is a transfer coating device comprising an engraved cylinder.

15. The facility according to claim 13, characterized in that said crosslinking station comprises a means for generating a flow of gas or gaseous mixture filled with moisture.

16. The facility according to claim 15, characterized in that it comprises a device for winding said coated flexible substrate over itself, and in that said means for generating said flow of gas or gaseous mixture filled with moisture is positioned upstream from said winding device.

17. The facility according to claim 13, characterized in that it comprises a device for forced cooling said hot melt the composition of the primary pattern.

18. The method according to claim 1, characterized in that said pattern is formed of distinct points that are spaced apart from each other.
